(19) United States
(12) Patent Application Publication
(10) Pub. No.: US 2009/0120976 A1
(43) Pub. Date: May 14, 2009

(54) Pivotal Spare Tire Carrier

(76) Inventor: Charles J. MacKarvich, Atlanta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/937,857

(22) Filed: Nov. 9, 2007

(51) Int. Cl. B62D 43/02

(52) U.S. Cl. 224/42.21

(57) ABSTRACT

A pivotal spare tire carrier (40) is mounted to a side frame segment (21) of a boat trailer (10). The proximal end of the support arm (50) is pivotally attached to the trailer frame on the outside surface thereof and tilts the tire from between mount and dismount positions outside the trailer frame and a travel position inside the trailer frame. When the tire is located in its travel position it is tilted approximately parallel to the facing surface of the hull of the boat.

### FIELD OF THE INVENTION

This invention concerns a tire carrier for pivotally mounting a spare tire on the frame of a boat trailer.

### BACKGROUND OF THE INVENTION

Typically, a boat trailer includes frame segments that form somewhat of an outline of the shape of the hull of the boat it carries. The trailer frame includes side frame segments that extend substantially parallel to the sides of the boat hull that support the boat amidships, and converging forward frame segments that extend forwardly of the side frame segments to the trailer tongue. The converging forward frame segments support the bow of the boat. The converging segments form a V-shape with each other as they join the tongue of the boat, and are of a configuration that generally matches the V-shape of the plan view of the boat hull.

Bunk boards and rollers are mounted on the trailer frame that directly support the boat above the trailer frame and allow the boat to be pulled on and off of the trailer. When the boat rests on the trailer, the upper portions of the hull might extend over certain portions of the trailer frame, but the lower portions of the boat hull converge downwardly and inwardly to the keel of the hull and extend downwardly into the inside space of the trailer frame. This also leaves a space between the segments of the trailer frame and the boat hull.

Typically, a boat trailer includes a spare tire that is mounted on the trailer frame. A convenient place for mounting a spare tire for the trailer may be on one of the converging converging frame segment so that the tire does not block the movement of the boat as the boat is moved longitudinally onto or off of the trailer. In other instances, the spare tire may be mounted on the inside surface of one of the converging trailer frame segments, with the tire inside the trailer frame and facing the converging bow of the boat.

In the configuration where the spare tire is mounted to the outside surface or the inside surface of one of the converging trailer frame segments, the tire is subjected to the vertical vibrations normally encountered by a boat trailer when in transit. The weight of the tire and the horizontal lever arm between the trailer frame and the tire tends to cause the tire to bounce vertically and about the trailer frame, tending to emphasize the amount of vibration. Also, the mounting of the tire in these positions may cause the tire to become obstructive to adjacent objects or personnel.

With regard to the spare tire mounted on the inside of a converging segment of the trailer frame, it may be awkward for the operator of the vehicle to mount the tire to or dismount the tire from the frame segment since the lug nuts that hold the tire in place face and may be closely spaced to the bow of the boat.

It would be desirable to have the spare tire for a boat trailer to be both accessible and out of the way of adjacent objects and personnel, and also readily available for mounting and de-mounting to the trailer. It is to the above noted problems and solutions that this invention is directed.

### SUMMARY OF THE INVENTION

Briefly described, this invention concerns a tire carrier for a boat trailer, with the tire carrier pivotally mounting the spare tire on the frame of a boat trailer. The boat trailer typically would include a frame made up of frame segments joined end-to-end in an approximate V-shaped configuration with opposed side frame segment, and converging frame segments that converge from the side frame segments toward a towing tongue of the trailer.

The tire carrier may include a support arm having a proximal end and a distal end, with the proximal end of the support arm pivotally mounted to the trailer frame and a tire rim support mounted to the distal end of the support arm and arranged to support the rim of the spare tire. The distal end of the support arm and the tire rim support mounted thereto are movable in an arc over the frame, positioned either partially over the inside of the frame or to a position outside of the frame.

The invention allows the tire to be positioned inside the frame for travel and outside the frame for access.

The support arm of the tire carrier may be in the form of a spread L-shape or open C-shape, having a first segment pivotal about the trailer frame to a substantially vertical attitude and a second segment sloped over the trailer frame when the first segment is in its substantially vertical attitude. This places the tire in a space generally inside the trailer frame, between the boat and the adjacent trailer frame segment.

The first segment of the support arm and a mounting bracket for the support arm may be formed to have abutting surfaces when the tire mounted on the support arm is pivoted to the outside of the boat, for maintaining the second segment of the support arm in an upwardly inclined attitude.

The support arm and the rim support for the tire may be formed to support a tire in a tilted position over the frame of the boat trailer for travel.

### BRIEF DESCRIPTION OF THE DRAWINGS

FIG. 1 is a plan view outline of the frame a boat trailer shown in solid lines, with a boat mounted on the trailer shown in dash lines.

FIG. 2 is a schematic view of a boat mounted on a trailer, showing the two positions of the spare tire, one position in the travel position and the other position in the mounting position.

FIG. 3 shows the tire carrier supporting the spare tire in its travel position.

FIG. 4 shows the tire carrier supporting the spare tire in its mounting and demounting position.

FIG. 5 is a perspective view of the tire carrier holding the spare tire in its mounting and demounting position.

FIG. 6 is a perspective view, similar to FIG. 5, but showing the tire carrier without the tire mounted thereto.

### DETAILED DESCRIPTION

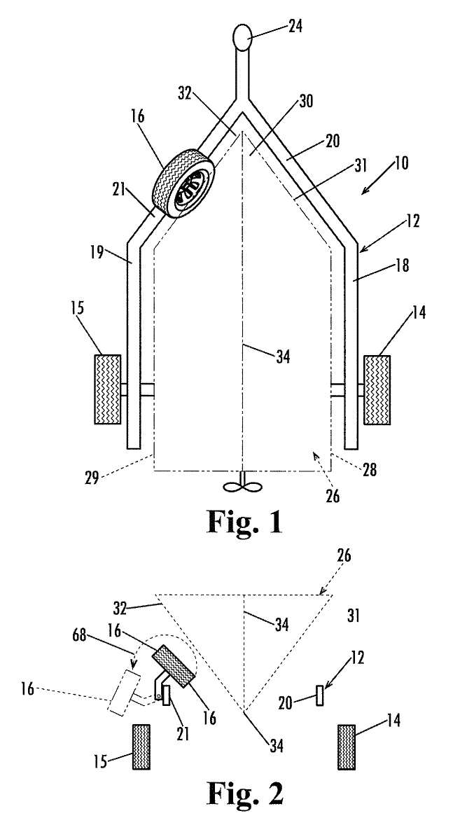

Referring now in more detail to the drawings, in which like numerals indicate like parts throughout the several views, FIG. 1 illustrates a boat trailer 10 that includes a trailer frame 12, road wheels 14 and 15, and spare tire 16. The trailer frame 12 includes side frame segments 18 and 19 that usually are substantially parallel to the amidships hull of the boat to be carried on the trailer. Converging frame segments 20 and 21 extend from the forward portions of the side frame segments, forming a V-shape and then joined to a trailer tongue 24. A boat 26 is shown in dash lines, with the opposed sides of the boat hull 28 and 29 being positioned over and inwardly of the side frame segments 18 and 19, and the converging sides of the bow 30 forming a V-shape. The converging sides 31 and 32 are approximately parallel to the converging frame segments 20 and 21 of the boat trailer. It will be noted that the bow as well as the hull is tapered inwardly toward a keel 34, as shown in FIG. 2. There are various bunk boards and rollers (not shown) that are mounted to the trailer frame to support the hull of the boat inside the trailer frame. The hull of the boat is supported inwardly of the trailer frame.

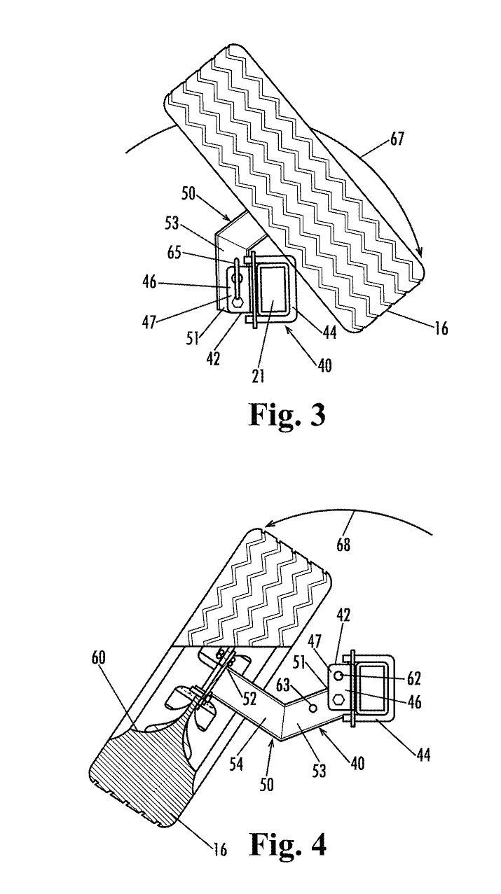

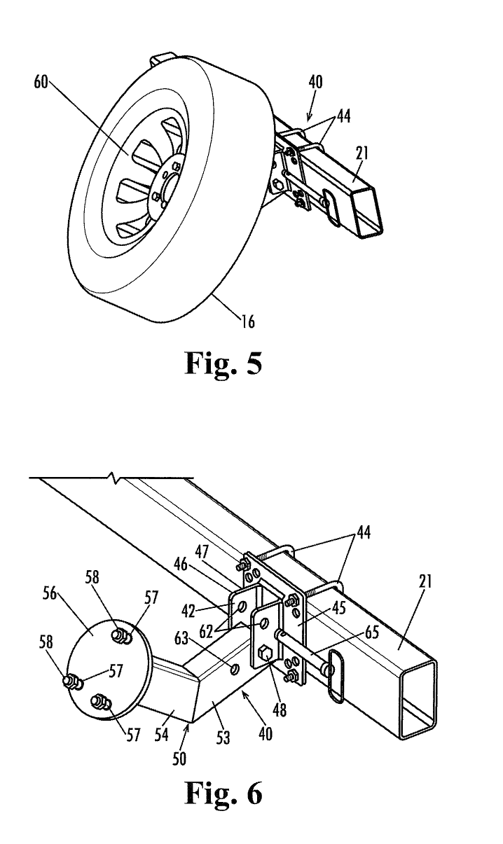

As shown in FIGS. 3-6, the pivotal spare tire carrier 40 is mounted to one of the converging frame segments 20 or 21. A support bracket 42 is mounted to a frame segment 21 by means of U-bolts 44, welding (not shown), or other conventional attachment means. The support bracket 42 includes a base plate 45 and a U-shaped clevis 46 having its back mounted to the base plate. The U-bolts fasten to the base plate. Aligned pivot openings (not shown) are formed in the wings of the clevis 46 and a pivot pin 48 is extended through the aligned openings of the clevis.

Support arm 50 is pivotally mounted in clevis 46 on pivot pin 48. The support arm includes a proximal end 51 that is inserted into the space between the wings of the clevis 46, and a distal end 52 opposed to the proximal end 51. The support arm is formed in segments 53 and 54, with the segments joined in a spread L-shape, or C-shape, in an obtuse angle, typically about 125°. However, other angles or shapes may be used as may be desired.

As shown in FIG. 6, rim support 56 is mounted to the distal end 52 of the support arm 50. The rim support 56 may be a flat plate having lugs 57 rigidly mounted thereto. Lug nuts 58 threadedly engage the lugs.

Spare tire 16 includes a rim 60 with the tire mounted to the rim in the conventional manner. The rim includes lug openings that are sized and spaced to receive the lugs 57 of the rim support 56. With this arrangement, the spare tire can be lifted and mounted on the rim support by slipping the lug openings of the rim over the lugs 57. The lug nuts 58 may then be threaded onto the lugs to rigidly support the spare tire 16 on the support arm 50.

Aligned lock openings 62 are formed in the wings 47 of the clevis 46 and lock receiving openings 63 are formed in the proximal segment of the support arm 50. As shown in FIG. 3, when the support arm 50 is tilted upwardly so that its proximal segment 53 is substantially vertically oriented, the lock receiving openings 63 will align with the lock openings 62 and a lock pin 65 is inserted through the aligned openings. This locks the support arm 50 with its proximal segment oriented substantially vertically and its distal segment sloped over the support bracket 42 and the frame segment 21. The lugs 57 of the rim support 56 will also be oriented in a tilted arrangement, facing the boat mounted on the trailer. As shown in the solid line illustration of FIG. 2, the spare tire 16 will be positioned generally inside and above the adjacent frame segment, in the space between the frame segment 21 and the facing surface of the hull of the boat 26.

When the lock pin 65 is removed from its openings 62 and 63 (FIG. 6), the support arm 50 is free to tilt in a counter-clockwise direction 68 (FIG. 4) to move the tire out of the space between the trailer frame segment 21 and the hull of the boat. Since the pivot pin 48 is supported on the outside of the trailer frame segment 21, the path of movement as shown by the arrows in FIGS. 2, 3 and 4 is such that there is little horizontal movement of the tire toward the boat hull, with most of the movement of the tire oriented away from the boat hull.

As shown in FIGS. 4 and 6, the proximal end 51 of the support arm engages the base of the clevis 46 when the support arm is tilted back out of the boat frame so that the support arm comes to rest in the position illustrated in FIGS. 4 and 6. Since the support arm segments 53 and 54 are angled with respect to one another, this causes the rim support to be faced at an upwardly tilted angle so that the lugs 57 also extend upwardly and are tilted away from the trailer. This makes it convenient for the operator of the boat trailer to mount and demount the tire and its rim from the rim support 56. Moreover, once the tire has been properly mounted on the lugs of the rim support, the tire, rim support, and support arm may be tilted back in the direction of the arrow 67 of FIG. 3 so that the tire is back to its travel position.

Although preferred embodiments of the invention have been disclosed in detail herein, it will be obvious to those skilled in the art that variations and modifications of the disclosed embodiments can be made without departing from the spirit and scope of the invention as set forth in the following claims.

What is claimed is:

1. A tire carrier for pivotally mounting a spare tire on the frame of a boat trailer, in which the frame includes an interior space for carrying a boat and said frame extends substantially horizontally over the ground surface, comprising:
a mounting bracket for attachment to the frame of the boat trailer,
a support arm having a proximal end and a distal end, said proximal end of said support arm pivotally mounted to said mounting bracket and said distal end of said support arm movable in an arc over the mounting bracket from a position outside of the frame to a position partially over the inside of the frame,
a rim support mounted to the distal end of said support arm and arranged to support a rim of a tire,
such that the tire can be positioned inside the frame for travel and outside the frame for access.

2. The tire carrier of claim 1, wherein said support arm is a spread L-shape having a first segment pivotal about said mounting bracket to a substantially vertical attitude and a second segment sloped over the interior of the frame of the boat trailer when the first segment is in its substantially vertical attitude.

3. The tire carrier of claim 2, wherein said first segment of the support arm and said mounting bracket are formed to have abutting surfaces when said first segment of the support arm is pivoted to the outside of the boat for maintaining said second segment of the support arm in an upwardly inclined attitude.

4. The tire carrier of claim 1, and further including a lock for locking said support arm to said support bracket in a fixed position with the tire inside the trailer frame.

5. The tire carrier of claim 4, wherein said support arm and said mounting bracket include alignable openings and said lock comprises a lock pin for insertion through the alignable holes.

6. The tire carrier of claim 1, wherein support arm and said rim support are formed to support a tire in a tilted position over the frame of the boat trailer.

7. The tire carrier of claim 1, wherein the frame of the boat trailer is angled substantially parallel to the bow of a boat resting on the trailer, and wherein said support arm and said rim support are formed to support a tire in a tilted position parallel to the bow of the boat.

8. The tire carrier of claim 1, wherein the frame of the boat trailer is angled to be substantially parallel to the bow of a boat resting on the trailer, and wherein said support arm and said rim support are formed to support a tire in a tilted position substantially parallel to the bow of the boat and between the boat and the frame of the trailer.

9. The tire carrier of claim 1, wherein lugs are mounted to said rim support for connecting a rim of a tire to the rim support.

10. A tire carrier for a boat trailer, said boat trailer including a trailer frame defining an inner space over which a boat is to be supported, said tire carrier comprising:
a support arm including a proximal end and a distal end remote from said proximal end,
said support arm pivotally mounted at its proximal end to said trailer frame,
a tire support mounted to said distal end of said support arm for supporting a tire and its rim,
said support arm, said mounting bracket, and said tire support configured to pivot said tire over the trailer frame between a position outside said trailer frame away from the boat supported on said trailer frame and a position inside said trailer frame between the trailer frame and the boat mounted on said trailer frame.

11. The tire carrier of claim 10, wherein
said support arm has a proximal segment at said proximal end and a distal segment at said distal end,
said distal segment is oriented at an obtuse angle with respect to said proximal segment,
such that said distal segment of said support arm is suspended over said trailer frame when said tire is in the position between the trailer frame and the boat is mounted on said trailer.

12. The tire carrier of claim 11, wherein
said tire includes a rim with lug-receiving holes, and
said tire support includes lugs for extending into the lug-receiving holes.

13. The tire carrier of claim 12, wherein
said support arm and said mounting bracket are configured to abut each other to maintain the tire support when positioned outside the trailer frame in a tilted position with the lugs of the tire support facing upwardly and sloped away from said trailer.

14. The tire carrier of claim 10, wherein,
said support arm has a proximal segment at said proximal end and a distal segment at said distal end,
said distal segment is oriented at an obtuse angle with respect to said proximal segment,
a mounting bracket for mounting said support arm to said trailer frame, said mounting bracket configured to pivotally support said proximal segment of said support arm about an axis parallel to and beside said trailer frame,
such that said proximal segment of said support arm is pivotal to a substantially upright attitude.

15. The tire carrier of claim 10, wherein
said support arm and said mounting bracket are configured to maintain the tire support when positioned inside the trailer frame in a tilted position with the lugs of the tire support sloped upwardly and toward the boat mounted on the trailer frame.

16. The tire carrier of claim 1, wherein
said boat trailer includes opposed substantially parallel side trailer segments and converging bow segments for supporting the boat with the bow of the boat positioned in approximately parallel relationship with said converging bow segments of the boat trailer, and
said mounting bracket mounted to one of said bow segments of said boat trailer.

17. A tire carrier for pivotally mounting a spare tire on the frame of a boat trailer, in which the frame includes an interior space for carrying a boat and the frame of the boat trailer is formed to have a space between the frame and the bow of the boat mounted on the frame,
a mounting bracket for attachment to the frame of said boat trailer,
a support arm having a proximal end pivotally mounted to said mounting bracket and a distal end configured to support a spare tire,
said support arm being shaped so that upon pivoting about the trailer frame moves the spare tire from a position outside the trailer frame to a position between the trailer frame and the boat mounted on said trailer frame.
